(19) United States
(12) Patent Application Publication
(10) Pub. No.: US 2004/0130535 A1
(43) Pub. Date: Jul. 8, 2004

(54) Panel comprising elements for controlling the air conditioning in a vehicle

(76) Inventors: Nicolas Dortin-Deguey, Versailles (FR); Sylvain Grisot, Le Chesnay (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/472,182

(22) PCT Filed: Feb. 14, 2002
(86) PCT No.: PCT/FR02/00559

(30) Foreign Application Priority Data
Mar. 26, 2001 (FR) 01/04021

(51) Int. Cl. G09G 5/00

(52) U.S. Cl. 345/173

(57) ABSTRACT

The invention relates to a panel (1) comprising elements (7, 11) for controlling the air conditioning in a vehicle. The inventive panel is characterised in that it comprises a central part which is intended to house some (11) of said elements and a peripheral part which is intended to house the remaining (7) elements. The configuration of said central part can be altered according to the control options provided on said panel (1).

The present invention relates to a panel containing means for controlling the air conditioning of a vehicle.

From U.S. Pat. No. 6,066,225 there is known such a panel containing means for controlling the ventilation mode as well as the air flow and temperature in the interior of the said passenger compartment.

In this prior art control panel, these control means comprise three separate rotary knobs distributed over a plate of elongated shape, these knobs permitting control of the ventilation mode, the air flow and the air temperature respectively.

Although this control panel permits the air conditioning of the passenger compartment of a motor vehicle to be conveniently controlled, it cannot be readily modularized in order to adapt it to vehicles offering different air-conditioning control options.

In fact, the layout of the control panel must be completely revised and new molds must be designed for each option.

The object of the present invention is to provide an air-conditioning control panel that can be modularized at less cost as a function of the planned air-conditioning control options.

This object of the invention is achieved with a panel containing means for controlling the air conditioning of a vehicle, characterized in that it contains a central part intended to receive certain of the said means and a peripheral part intended to receive the others of the said means, the conformation of the said central part being modularizable as a function of the control options provided on the said panel.

By virtue of these characteristics, it is sufficient to change the central part of the control panel whenever it is desired to change certain control means corresponding to other control options.

According to other characteristics of the control panel according to the invention:

the said central part substantially defines a disk, and the said peripheral part substantially defines a ring surrounding the said disk,

the said certain means are adapted to control the flow and temperature of the air arriving in the interior of the passenger compartment of the said vehicle, and the said other means are adapted to control the mode of ventilation in the interior of the said passenger compartment,

the said other means comprise means chosen from within the group comprising means for controlling the distribution of air, means for activating an air-cooling system and means for recycling the air of the said passenger compartment,

the said certain means comprise a first series of pushbuttons,

the said other means comprise a second series of pushbuttons,

the said panel contains fixed ridges interposed between the pushbuttons of the said second series of pushbuttons,

the said certain means comprise at least one rotary knob,

the said panel contains a display screen situated in the said central part.

Other characteristics and advantages of the present invention will become evident upon reading the description hereinafter and upon examining the attached drawing, wherein:

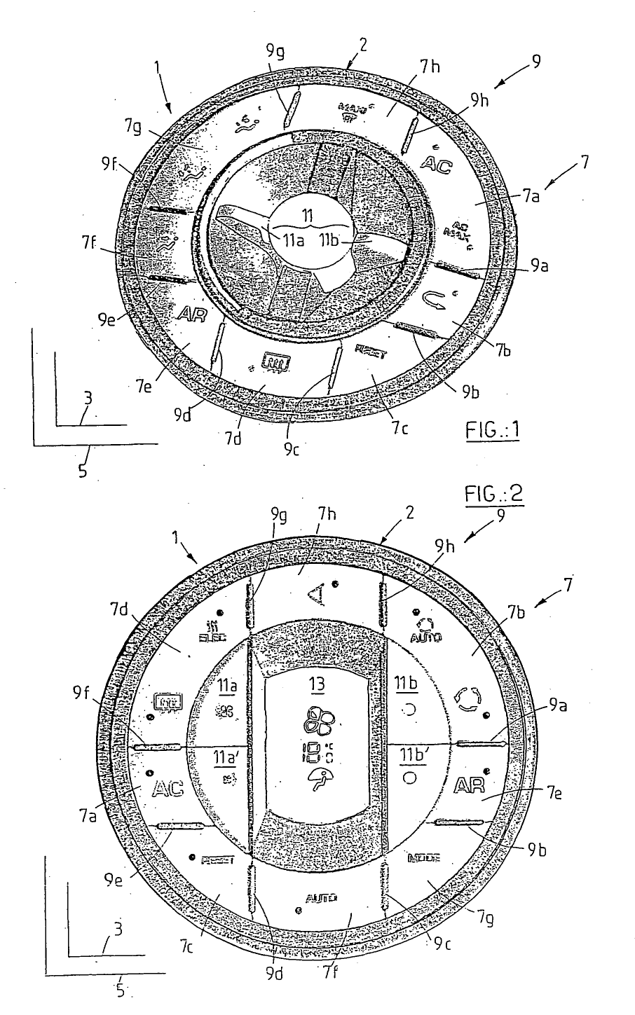

FIG. 1 is a front view of a first embodiment of the control panel according to the invention, and

FIG. 2 is a perspective view of a second embodiment of the control panel according to the invention.

On these figures, like reference symbols denote identical or analogous means or groups of means.

Reference is now made to FIG. 1, which illustrates a first embodiment of a control panel 1 according to the invention, containing a plate 2 intended to be mounted in the interior of passenger compartment 3 of a motor vehicle 5.

This control panel 1 is equipped with means 7 for controlling the mode of ventilation in the interior of passenger compartment 3, these means being mounted on plate 2.

These means may comprise, for example, a first series of pushbuttons 7a, 7b, 7c, 7e, 7f, 7g, 7h, for control respectively of an air-cooling system, the recycling of air in the interior of passenger compartment 3, zero reset of the control panel, defogging of the rear window, the arrival of air at the rear of passenger compartment 3, the arrival of air at mid-height relative to the passenger, the arrival of air at the feet and head of the passenger, and defogging of the windshield.

A common feature of pushbuttons 7d to 7h is that they permit the distribution of air inside passenger compartment 3 to be adapted as a function of the needs of the passengers.

Preferably, ridges 9a to 9h integral with plate 2 are interposed between pushbuttons 7a to 7h.

The control panel according to the invention is also equipped with means 11 for controlling the flow and temperature of the air arriving in passenger compartment 3.

These means may comprise, for example, first and second rotary knobs 11a and 11b respectively, mounted coaxially on plate 2.

Means 11 for controlling the flow and temperature of the air arriving in passenger compartment 3, and means 7 for controlling the mode of ventilation in this passenger compartment are disposed respectively in a central part and in a peripheral part of plate 2.

Of course, this arrangement could be inverted.

Preferably, and as illustrated in FIG. 1, the central part of plate 2 substantially defines a disk, and the peripheral part of plate 2 substantially defines a ring surrounding this disk.

Reference is now made to FIG. 2, which illustrates a second embodiment of a control panel according to the invention.

In the following, the description will be limited to the differences of this embodiment compared with the preceding embodiment.

In this second embodiment, means 11 for controlling the flow and temperature of air arriving in passenger compartment 3 comprise a second series of pushbuttons 11a, 11a′ and 11b, 11b′, disposed in the inside of the ring defined by the first series of pushbuttons 7a to 7h.

Preferably, a display screen 13 is disposed in the central part of plate 2, between pushbuttons 11a, 11a′ on the one hand and 11b, 11b′ on the other.

This display screen 13 is designed to indicate different types of information about the operation of air conditioning in the interior of passenger compartment 3: distribution mode, flow, temperature, etc.

The mode of operation and the advantages of the control panel according to the invention result directly from the foregoing description.

In the case of the first embodiment, a passenger wishing to control the air conditioning of passenger compartment 3 of vehicle 5 moves his hand to control panel 1 then selects the ventilation mode by pressing the appropriate pushbuttons 7, then selects the air flow arriving in the interior of passenger compartment 3 by turning knob 11a in the appropriate direction, then finally selects the temperature of this air by turning knob 11b.

Of course, these selections may be accomplished in a different order.

In the case of the second embodiment, the passenger selects the air flow by pressing one of the two pushbuttons 11a, 11a′, then he selects the temperature of this air by pressing one of the two pushbuttons 11b, 11b′.

Display screen 13 permits the passenger to obtain confirmation of the adjustments that he has made.

As can be understood in the light of the foregoing, when it is desired to change certain control means corresponding to other options, it is sufficient to change the central part of the control panel in order to dispose the new control means therein, the peripheral part of the panel remaining identical.

In terms of production by molding, this means that it is sufficient to change the core of the mold in order to adapt the panel as a function of the planned control options.

This partial change of the production mold permits substantial savings to be achieved compared with the necessity of resorting to a mold specific to each control option.

It will also be noted that, by virtue of its modularizable character, the control panel according to the invention can be easily adapted in order to equip selectively a right-hand drive vehicle or a left-hand drive vehicle.

It will also be noted that, by virtue of the substantially circular shape of plate 2, the different air-conditioning control means 7, 11 are grouped together in a very compact space, thus making it possible to consider disposing control panel 1 according to the invention elsewhere than on the dashboard (not illustrated) of motor vehicle 3, and especially on each door (not illustrated) of this vehicle.

In this way control panel 1 becomes highly accessible to each passenger of the vehicle, which permits ergonomics much more satisfactory than in the prior art to be achieved.

It will also be noted that the circular form of plate 2 makes the group of control means 7, 11 highly accessible to the fingers of the hand of a user for any given position thereof, which also contributes to improvement of the ergonomics compared with the prior art.

This accessibility of control means 7, 11 is particularly advantageous when the control panel according to the invention must be manipulated “blind”, as is the case, for example, in the dark.

It will also be noted that, the presence of ridges 9a to 9b makes it possible to guide the fingers of the hand, and thus to facilitate such manipulation.

It will also be observed that the control panel according to the invention has an innovative esthetic appearance, consistent in particular with the forms that will be found in the vehicles of the coming years.

Of course, the present invention is not limited to the described and illustrated embodiment, provided as an illustrative and non-limitative example.

1. A panel (1) containing means (7, 11) for controlling the air conditioning of a vehicle, characterized in that it contains a central part intended to receive certain (11) of the said means and a peripheral part intended to receive the others (7) of the said means, the conformation of the said central part being modularizable as a function of the control options provided on the said panel (1).

2. A panel (1) according to claim 1, characterized in that the said central part substantially defines a disk, and in that the said peripheral part substantially defines a ring surrounding the said disk.

3. A panel (1) according to one of claims 1 or 2, characterized in that the said certain means (11) are adapted to control the flow and temperature of the air arriving in the interior of the passenger compartment (3) of the said vehicle, and in that the said other means (7) are adapted to control the mode of ventilation in the interior of the said passenger compartment (3).

4. A panel (1) according to claim 3, characterized in that the said other means (7) comprise means chosen from within the group comprising means for controlling the distribution of air, means for activating an air-cooling system and means for recycling the air of the said passenger compartment (3).

5. A panel (1) according to any one of the preceding claims, characterized in that the said certain means (11) comprise a first series of pushbuttons (11a, 11a′, 11b, 11b′).

6. A panel (1) according to any one of the preceding claims, characterized in that the said other means (7) comprise a second series of pushbuttons (7a to 7h)

7. A panel (1) according to claim 6, characterized in that it contains fixed ridges (9a to 9h) interposed between the pushbuttons of the said second series of pushbuttons (7a to 7h).

8. A panel (1) according to any one of the preceding claims, characterized in that the said certain means (11) comprise at least one rotary knob (11a, 11b).

9. A panel (1) according to any one of the preceding claims, characterized in that it contains a display screen (13) situated in the said central part.
